(19) United States
(12) Patent Application Publication
(10) Pub. No.: US 2024/0426474 A1
(43) Pub. Date: Dec. 26, 2024

(54) FLAME LAMP DEVICE

(71) Applicant: PLM Global Logistics, LLC, Eau Claire, WI (US)

(72) Inventor: DEAN HANSEN, Eau Claire, WI (US)

(21) Appl. No.: 18/826,748

(22) Filed: Sep. 6, 2024

Related U.S. Application Data
(63) Continuation-in-part of application No. 18/180,386, filed on Mar. 8, 2023, now Pat. No. 12,111,027.

(51) Int. Cl. F21V 35/00; F21V 3/02; F21V 21/08; F21V 37/00

(52) U.S. Cl. CPC F21V 35/00; F21V 3/02; F21V 37/00; F21V 21/0824

(57) ABSTRACT

Devices, systems, and methods of allowing external air to access a chamber of a flame lamp device, including positioning upstanding transparent panels in slots of a top member of a base, the transparent panels in part forming a chamber, the base having at least one side vent, the panels positioned to form elongated gaps between adjacent transparent panels, orienting the panels in the slots in a spaced relationship with the base which allows external air to enter the at least one vent into the base and upward through at least one opening in the top member and into the chamber to fuel a flame.

### CROSS-REFERENCE TO RELATED APPLICATION

The present application is a continuation-in-part of, and claims priority to, co-pending U.S. patent application Ser. No. 18/180,386, filed Mar. 8, 2023, which is hereby incorporated by reference as if fully reproduced herein.

### DESCRIPTION

### Background of the Invention

Lamps, lanterns, torch lamps or flame lamp devices are used to provide outdoor lighting, warmth and decoration. Sometimes flame lamps are positioned as a torch on an upstanding post, or multiple torch devices may be oriented to outline a perimeter of a patio, camp site, camp fire or other outdoor area. Some flame lamps may also be positioned on a table or other surface for light, heat and enjoyment. Some examples of gas supplied torch lamps or similar devices for which patents have been sought or granted include US Patent Application No. 2009/0016048 to McBrien et al., and U.S. Pat. No. 7,097,448, to Chesney. While such devices or systems may have benefits, there is room for improvement.

### SUMMARY OF THE INVENTION

Applicant recognizes past flame devices may be lacking in supplying sufficient airflow to a flame lamp device or torch to keep the flame burning as desired. Heretofore unappreciated was allowing multiple sources of external airflow, from multiple dimensions, into a chamber area where a flame is to burn. The present disclosure in one aspect pertains to a flame lamp device configured to allow external airflow to a chamber defined in part by a plurality of transparent panels upstanding from a base of the lamp device. The panels define elongated gaps between edges of adjacent panels which allow external air to flow into the chamber. In addition to the elongated gaps being a source of airflow, applicants present configurations for further external air sources. The base includes a top member having at least one air opening for air to also flow upward into the chamber. In one aspect the base includes a bottom member having at least one bottom air opening which allows external air to flow through the bottom opening, through the top opening and into the chamber to also fuel the flame in the chamber. In one aspect the base includes at least one side vent which allows external air to also flow through the side vent into the base, through the top opening and into the chamber to fuel the flame.

In a further aspect a flame lamp device includes a base having a top portion and a plurality of side vents, at least three transparent panels projecting upward from the base, the panels oriented such that adjacent panels define elongated gaps between edges of the adjacent panels, the transparent panels at least in part defining a chamber, the top portion of the base having an opening configured to allow a flame to project into the chamber where the side vents and the elongated gaps allow air to flow into the chamber to feed the flame. In aspects the device includes a base which receives four or more transparent panels forming the chamber.

In a further aspect a flame lamp device has a base having a top member and a bottom member, at least one air vent oriented between the top member and the bottom member, the top member having a plurality of top member air openings, a top member flame opening configured to allow a flame to project upward from the base, and a plurality of slots configured to receive transparent members, the bottom member having a plurality of bottom member air openings, an oil receptacle configured to receive oil to fuel the flame where the bottom member air openings and the at least one air vent allow air to flow into the base and upward through the top member air openings. In other aspects, instead of use of an oil receptacle, the device is configured to receive a candle holder and/or candle, with the flame of the candle fed air via the aforementioned vents.

In a further aspect a flame lamp device has a base having a top member and a bottom member, a plurality of air vents oriented between the top member and the bottom member, the top member having a plurality of top member air openings and a plurality of slots configured to receive transparent panels, a plurality of transparent panels positioned in the slots, the transparent panels oriented such that adjacent transparent panels define elongated gaps between edges of the adjacent transparent panels, the transparent panels oriented in a spaced relationship with respect to the bottom member.

Further aspects include methods of allowing external air to access a chamber of a flame lamp device, including positioning upstanding transparent panels in slots at a top member of a base, the transparent panels in part forming a chamber, the base having at least one side vent, the panels positioned to form elongated gaps between adjacent transparent panels, orienting the panels in the slots in a spaced relationship with the base to allow external air to enter the at least one vent into the base and upward through the top member and into the chamber.

The above partial summary of the present invention is not intended to describe each illustrated embodiment, aspect, or every implementation of the present invention. The figures and detailed description and claims that follow more particularly exemplify these and other embodiments and further aspects of the invention.

### BRIEF DESCRIPTION OF THE DRAWINGS

FIG. 1 is a perspective view of a device in accordance with aspects of the invention.

FIG. 2 is a front view of the device of FIG. 1.

FIG. 3 is a partial top perspective view of the device of FIG. 1.

FIG. 4 is a partial bottom perspective view of the device of FIG. 1.

FIG. 5 is a partial front view of the device of FIG. 1.

FIG. 6 is a top view of the device of FIG. 1.

FIG. 7 is a bottom view of the device of FIG. 1 with aspects removed for clarity.

FIG. 8 is an exploded view of the device of FIG. 1.

FIG. 9 is a is a top view of a component for use with the device viewed along line 9-9 of FIG. 8.

FIG. 10 is a section view of the device taken along line 10-10 of FIG. 8.

FIG. 11 is a partial section view of the device taken along line 11-11 of FIG. 10.

FIG. 12 is a front view of a device in accordance with further aspects of the invention.

FIG. 13 is an exploded perspective view of the device of FIG. 12.

FIG. 14 is a section view of the device taken along line 14-14 of FIG. 13.

FIG. 15 is a section view of the device taken along line 15-15 of FIG. 1.

FIG. 16 is a section view of the device in accordance with further aspects of the invention.

FIG. 17 is a section view of the device in accordance with further aspects of the invention.

FIG. 18 is a section view of the device in accordance with further aspects of the invention.

FIG. 19 is a partial perspective view of the device in accordance with further aspects of the invention.

While the invention is amenable to various modifications and alternative forms, specifics thereof have been shown by way of example in the drawings and will be described in detail. It should be understood, however, that the intention is not necessarily to limit the invention to the particular embodiments, aspects and features described. On the contrary, the intention is to cover all modifications, equivalents, and alternatives falling within the spirit and scope of the invention and as defined by the appended claims.

### DETAILED DESCRIPTION OF THE INVENTION

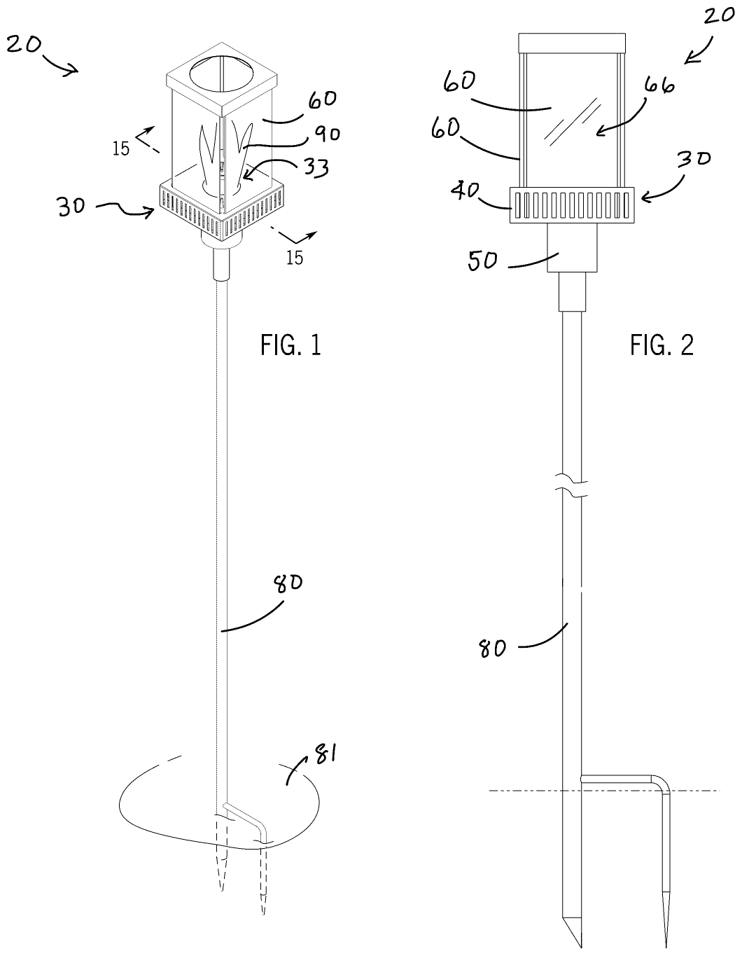

Referring to FIGS. 1-19, aspects of the devices, systems and methods of the invention are shown. Device 20 is a flame lamp device which displays a flame 90 visible through transparent panels 60 such as glass, plastic or other transparent material. Device 20 is configured such that flame 90 may swirl within a chamber 66 defined at least in part by the transparent panels 60. As described in greater detail herein, air flows into the chamber 66 through elongated gaps 64 between respective adjacent transparent panels 60 which panels 60 project upward from a base 30. Air may also flow into the chamber 66 through air openings 36 in the base via side vents 44 of the base 30 and/or via air openings 39 in a bottom member 38 of the base 30. In one aspect device 20 is used in conjunction with a stake 80 for insertion of the device 20 into the ground 81. In other aspects device 21 is a tabletop variety for use on a tabletop or similar surface. The flame 90 may be produced at a wick 92 of a candle 88, a candle 88 positioned within a candle holder 86, or at a wick 92 in communication with fuel from a fuel reservoir within the base 30.

FIG. 1 and FIG. 2 show device 20 in conjunction with a removable stake 80 and inserted into the ground 81 in a representative manner. Stake 80 is detachable and may come in multiple segments for easy storage and shipping. Stake 80 may be of a screw-in or twist and adjust variety. Stake 80 connects to base 30 of device 20, and in one instance may connect to a stem 50 associated with base 30. In aspects the stem 50 is part of base 30 and in other aspects stem 50 connects to base 30 directly. Device 20 may be retrofitted by connecting a stake 80 to the base 30 or stem 50 as desired.

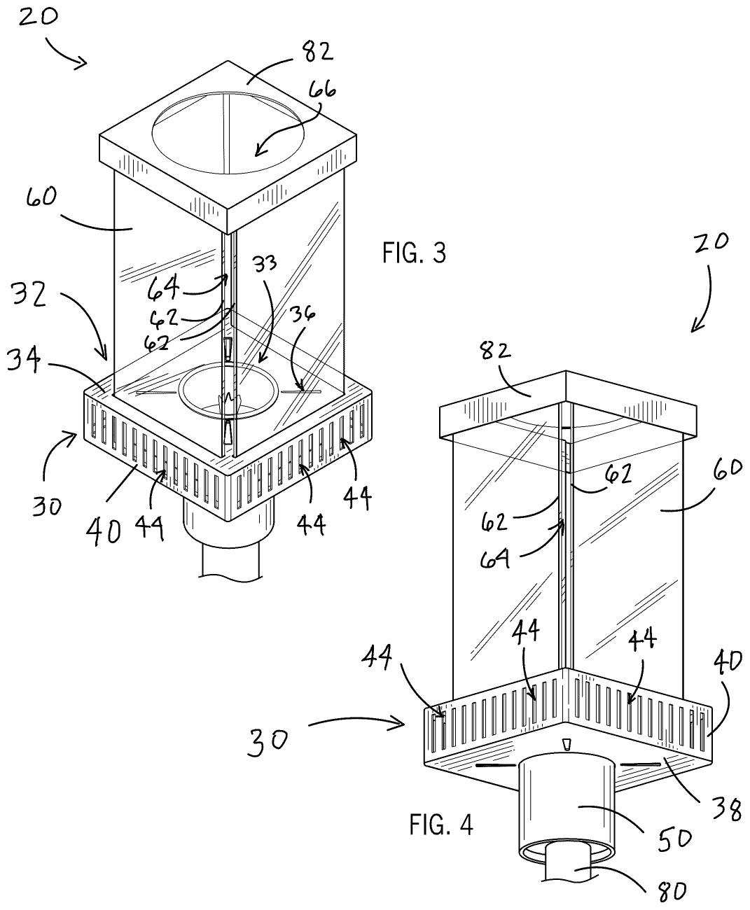

FIG. 3 and FIG. 4 show close-up perspective views of device 20 having a base 30 having a top portion 32 and a plurality of side vents 44. Top portion 32 includes a top portion opening 33 which allows a flame, such as flame 90, to project into the chamber 66. In one aspect the top portion 32 includes a top member 34. The panels 60 include edges 62. The panels 60 project upward from base 30 and are oriented such that adjacent panels 60 define elongate gaps 64 between respective edges 62 of adjacent panels 60. The elongated gaps 64 allow external air to flow into the chamber 66 to feed the flame 90. The side vents 44 also allow external air to flow into the chamber to feed the flame 90. In one aspect top member 34 includes top member openings, or air openings 36 which allow air to pass from the side vents 44 into the chamber 66. External air passes through side vents 44, into base 30, and upward via top member air openings 36. In aspects, device 20, 21 includes a bottom member 38 where bottom member 38 includes bottom member air openings 39. External air passes through bottom air openings 38 into base 30 and upward through air openings 36 into the chamber 66 to fuel the flame 90. Applicants have found that having multiple paths for feeding external air to the chamber 66 provides a desired flame structure or flame display and sufficient external air to allow flame 90 to continue to burn. External air enters the sides of the chamber via the longitudinal gaps and also enters at a bottom area of the chamber to provide the desired flame attributes.

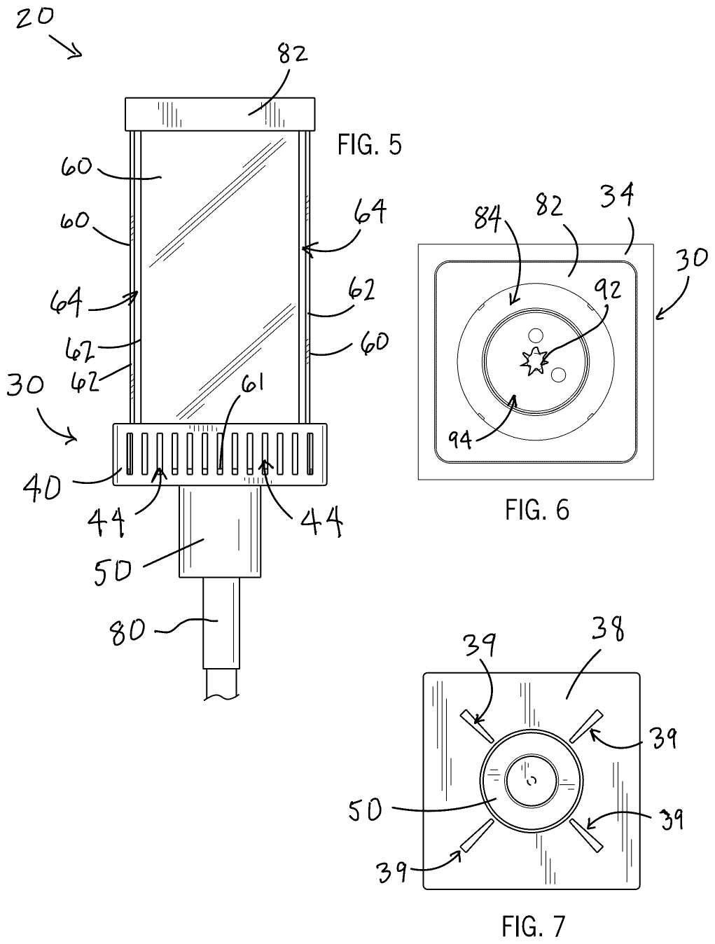

FIG. 5 is a closeup view of device 20 and shows the panels 60 positioned within base 30. In one aspect, panel 60 includes a panel bottom edge 61. As shown in FIG. 5, panel bottom edge 61 is positioned in a spaced relationship with respect to a bottom of the base 30. Particularly, panel bottom edge 61 is in a spaced relationship with respect to bottom member 38. This spaced relationship allows external air flowing in from the side vents 44 to also flow further into the base 30 and upward to the chamber 66. A lid 82 is provided at an upper area of device 20. Lid 82 secures the upper portions of panels 60 in a stable arrangement so the panels remain upright and avoid tilt or skewing. Lid 82 includes a lid opening 84 to allow flame and gases and heat to escape upward from chamber 66 and device 20.

FIG. 6 is a top view of device 20, 21 showing wick 92 visible through lid opening 84 of lid 82. In one aspect a wick cup 94 is utilized to hold the wick 92 and to also capture extra oils and debris. In reference to FIG. 9, wick cup 94 includes a wick opening 95 to accommodate receipt of the wick 92 and allows the wick 92 to pass through the wick cup 94 and into an oil receptacle 55. Wick cup 94 also includes at least one port 96 to allow extra oil to pass through wick cup 94 and into oil receptacle. Port 96 allows gravity removal of excess oil to minimize or prevent oil buildup and inadvertent ignition of the oil (or inadvertent ignition of other dangerous fuel materials which might be present in wick cup 94). In one aspect wick cup 94 includes multiple ports 96. In one aspect wick cup 94 includes a rim or cup lip 98. Cup lip 98 allows for wick cup 94 to insert into a top member opening where the cup lip 98 allows the wick cup 94 to hang downward into base 30. In other aspects a candle 88 may be alternatively be substituted for the wick cup 94. A candle holder 86 which contains a candle 88 may also be inserted into the base 30 instead of the wick cup 94. The candle 88 includes a wick for producing a flame.

FIG. 7 shows a bottom view of device 20. Base 30 includes a bottom member 38. In aspects, bottom member 38 includes bottom member air openings 39. While FIG. 7 depicts use of four openings 39, additional openings and opening configurations may be used. Openings 39 are optional in some instances, such as with a tabletop variety with device 21. In some aspects device 21 may also include feet or spacers to allow bottom 38 to be oriented slightly upward from a tabletop to allow a gap for additional external air to enter chamber 66 via bottom 38.

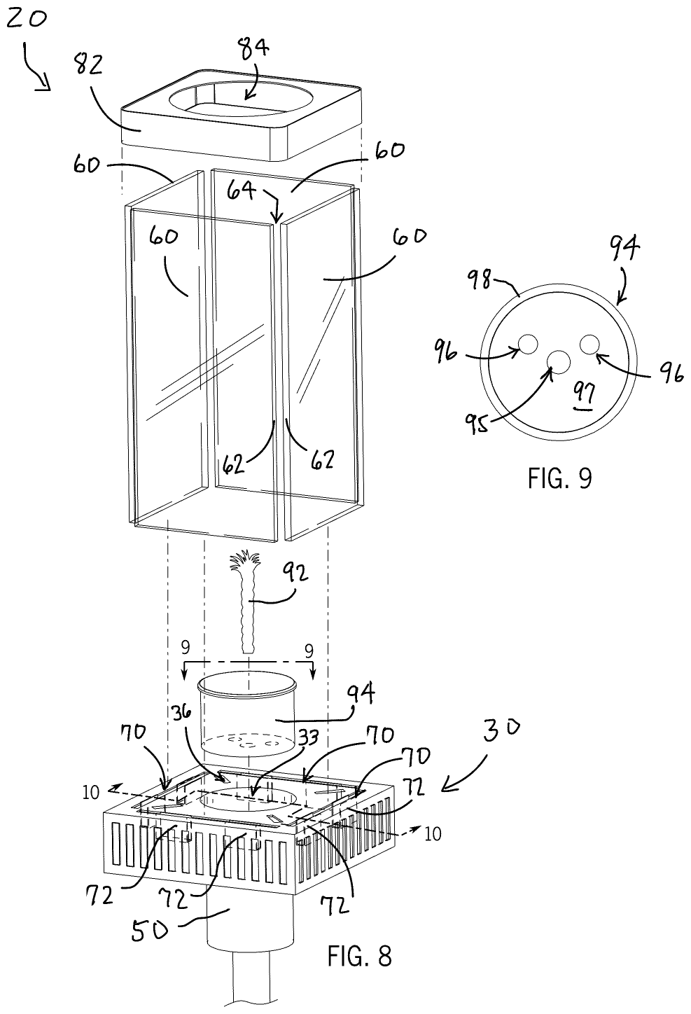

FIG. 8 is an exploded perspective view of device 20. Base 30 includes slots 70 which are configured to receive panels 60. Slots 70 are configured such that when panels 60 insert into slots 70, the panels 60 form the elongated gaps 64. In one aspect, the base 30 of device 20 includes four slots 70 and receives four panels 60. In other aspects, base 30 may include three slots 70 to receive three panels 60 for a triangular arrangement. In other aspects, base 30 may include five or more slots to receive five or more panels 60 for alternative arrangements. In one aspect, slots 70 have rectangular openings to receive a rectangular end of a panel 60. In alternative aspects, curved slots and curved transparent panels may also be used, while still maintaining elongated gaps 64. Base 30 shown in FIG. 8 is rectangular. In other aspects, base 30 may be cylindrical with rounded sides having side vents 44 therein. Base 30 may be of other (non-rectangular) shape, provided base 30 includes vents to allow external air to pass into the base 30, beneath panels 60, and upward into a chamber 66.

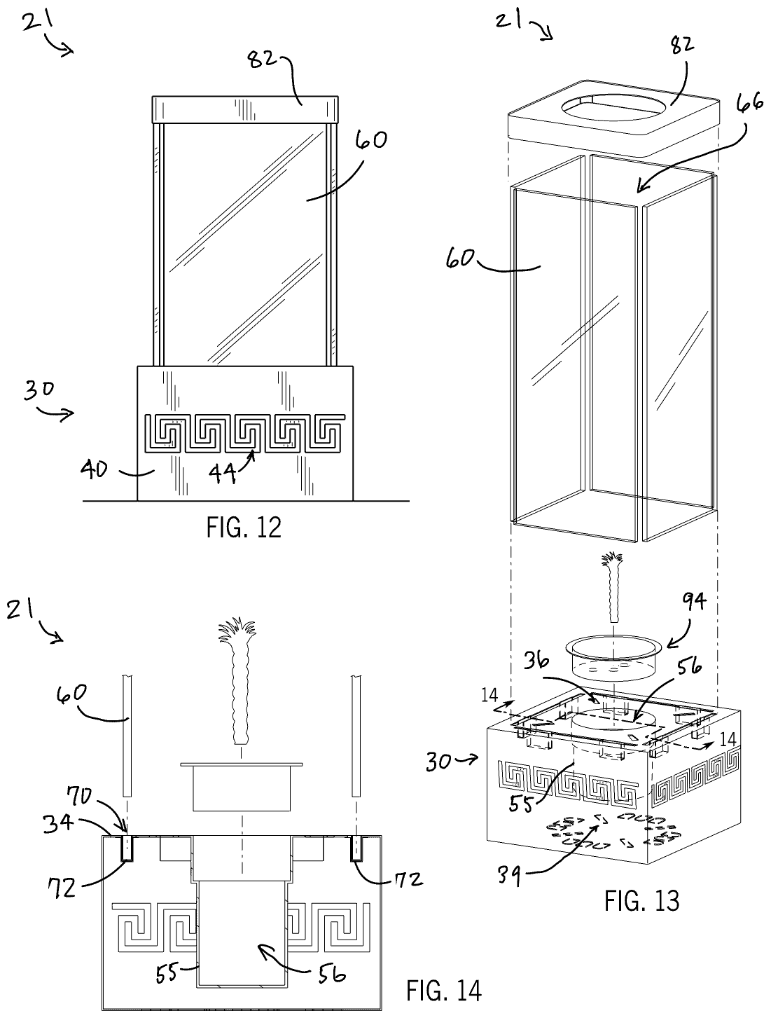

In one aspect FIG. 8 shows base 30 having a top portion opening 33 leading to a cavity in which wick cup 94 is positioned. Top portion opening 33 also leads to a fuel receptacle, such as an oil receptacle 55. The oil receptacle 55 defines an oil reservoir 56 for storage of lamp oil, for instance. In one aspect oil receptacle 55 is positioned below base 30. In other aspects it may be appreciated that oil receptacle 55 may be positioned within base 30. In one aspect, with respect to FIG. 12, oil receptacle is positioned within base 30. In one aspect oil receptacle 55 is positioned within stem 50. In further reference to FIG. 8, wick cup 94 inserts into base 30 and panels 60 insert into slots 70 of base 30. In yet further aspects, a candle holder 86 having a candle 88 having a wick 92 is positioned in the base as presented in FIG. 11. In alternatives, a candle 88 having a wick 92 may also be inserted into the base without use of a candle holder 86.

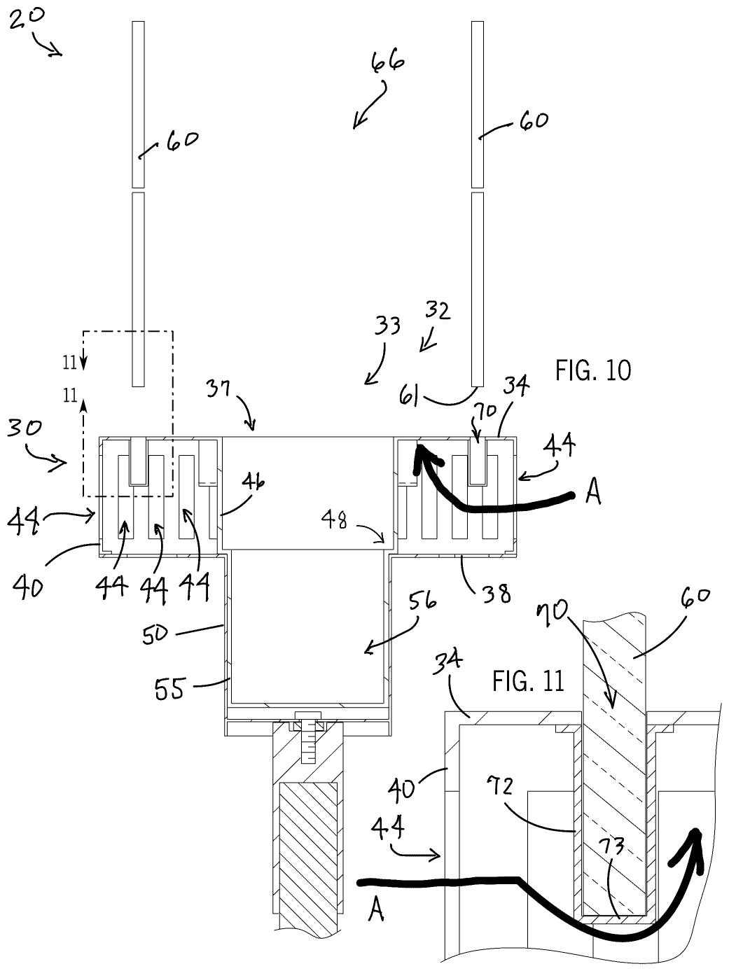

FIG. 10 is a section view of device 20 and shows multiple vents 44 at base 30. Vents 44 allow external air to enter the base 30. In one aspect, vents 44 are positioned about a perimeter of base 30. In one aspect, vents 44 are defined by a side member 40. In one aspect side member 40 comprises four segments which form about a perimeter of the base in a rectangular orientation. In one aspect the perimeter is a square perimeter as represented in examples of the drawings. More or fewer vents 44 may be utilized as desired. FIG. 10 also depicts an air flow represented by Arrow A, showing air flowing into a vent 44 of side member 40. The air flows beneath a panel bottom edge 61 of a panel inserted into the base 30. Particularly, and also with reference to FIG. 11, panel 60 inserts into slot 70 and is held into position in one aspect by a cradle 72. Cradle 72 comprises bottom and side walls, where a bottom wall 73 receives panel bottom edge 61 to retain panel 60 in a suspended orientation. More particularly, cradle 72 prevents panel 60 from sliding further into base 30, and allows panel 60 to be oriented in a spaced relationship with respect to a bottom of the base 30, such a bottom member 38. This spaced relationship allows for air to travel into base 30 from bents 44, below panel 60, and upward toward chamber 66 (see, for instance, air flow arrow A in FIG. 10 and FIG. 11). The flowing air enters the chamber via openings 36. In further reference to FIG. 8, base 30 includes a plurality of cradles 72. In one aspect, two cradles 72 are provided for each side of the base 30. Additional or fewer cradles 72 may be utilized. In one aspect cradle 72 is configured with tapering side walls to accommodate a friction fit with a lower portion of a panel 60 so better secure the panel in an upright and stable orientation. In one aspect, cradle 72 is positioned such that bottom wall 73 is positioned with at least a quarter inch of clearance from bottom of base 30. In aspects, at least an inch or more of clearance from a bottom of base 30 is provided.

In alternatives to use of a cradle 72, a porous block may be positioned upon or adjacent bottom member 38 so that bottom edge 61 of a panel 60 rests upon the block which nonetheless allows air to flow through the block and under the panel 60. A single block or multiple blocks may be utilized within base 30 to accommodate the air flow in this manner.

FIG. 10 shows bottom member 38 as integral with stem 50, i.e., made from the same layer of material. It may be appreciated, however, that bottom member 38 is a singular piece connected to stem 50. In one aspect stem 50 may be secured to bottom member 38 by welding or other connection or abutting means. In one aspect with respect to FIG. 10, oil receptacle 55 is a singular piece spanning upward to a top member 34. It may be appreciated, however, that oil receptacle 55 is a singular piece within stem 55, where an annular wall 46 may extend upward within base 30 to receive wick cup 94. Annular wall in one instance is separate from oil receptacle 55, yet align together when assembled. In FIG. 10, annular wall has an inner diameter greater than an inner diameter of oil receptacle 55. The oil receptacle 55 also includes an annular wall. In one aspect, the annular wall 46 and the annular wall of receptacle 55 form a shoulder 48, where an inner diameter of the annular wall is greater than the inner diameter of the receptacle 55. The shoulder 48 allows a wick cup 94, or candle holder 86, or candle 88 to about against the shoulder to maintain a desired position. In one aspect annular wall and receptacle 55 have the same inner diameter. Having a same diameter presents a smooth transition from annular wall 46 into receptacle 55. Wick cup 94 inserts into annular wall 46, which allows the wick 92 to extend downward into receptacle 55. In other aspects, top portion 32 may include a top portion opening 33 that is positioned above a top member 34, such as where a wick cup 94 may be positioned in a more upward location as compared to what is shown in the drawings, or in a case where the flame is formed at a more upward location compared to what is shown. In alternatives, a gas-fed flame may be produced at the top portion opening 33, so that a wick cup 94 is not present. In alternatives, a different fuel source may be used. In yet further aspects, a candle 88 or candle holder 86 may be used to produce the flame. In one aspect a gas line is oriented so that an exit port of the gas line is situated in or near the annular wall 46 or otherwise within flame opening 37, and in some cases above opening 37 to allow for a supply of gas to fuel a flame 90. A spark generator or ignition system (or port hole for insertion of a match or flame) may be included within or near base 30 to accommodate lighting of a gas flame.

FIG. 12, FIG. 13 and FIG. 14 show flame lamp device 21 in an alternative aspect. Base 30 is configured to rest upon a table or other surface. In aspects, vent 44 may be a single vent or comprise a plurality of vents 44, or may comprise a design of a single vent 44 at a side of base 30. Vent 44 may also present an artistic design or other pattern. While a side member 40 is used as part of base 30, it may be appreciated that a side member in not necessarily required, provided a plurality of side vents 44 are present. For instance, side vents 44 may comprise large open areas posts which support top member 34 in a spaced relationship from bottom member 38. The side vents 44 of device 20, 21 may be large gaps or holes between other structures, and not simply slits or slots or holes presented in a panel.

Multiple transparent panels 60 insert into slots 70 of base 30 and form elongated gaps 64 as with the device 20. Additional features of device 20 may also be incorporated into the device 21. As shown in FIG. 14, cradles 72 are used in one aspect to retain panels in a spaced relationship with a bottom of base 30 to accommodate the air flow as shown in FIG. 10 and FIG. 11. A wick cup 94 may insert into base 30 and a wick 92 may draw lamp oil from oil reservoir 56. A gas fed system as referenced above with device 20 may also be utilized. A block system may also be utilized as reference with device 20 to provide the air spaces below panels 60 to assist with providing external air to chamber 66. FIG. 13 shows optional openings 39 in a bottom of base 30. In further aspects, feet or spacers may be provided at a bottom of base 30 to provide a space for external air to enter the bottom of base 30 and travel upward through air openings 36 into chamber 66 to fuel the flame 90.

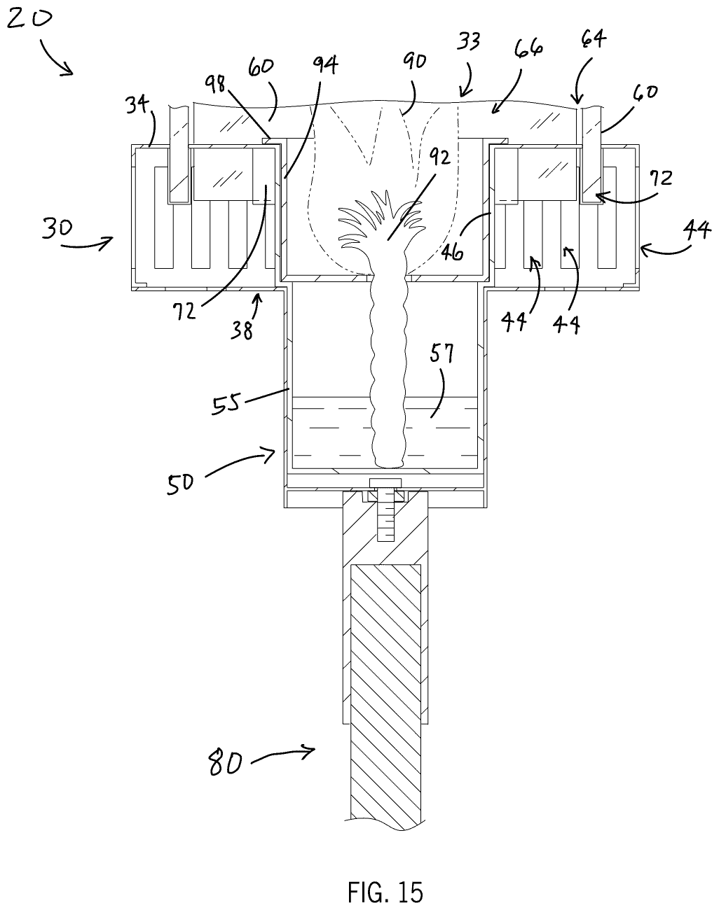

FIG. 15 is a section view of device 20 and shows a flame 90 on wick 92 within chamber 66. In operation, lamp oil 57 may be positioned in oil receptacle 55. A wick 92 is inserted into and through wick opening 95 within wick cup 94. Wick cup 94 is inserted into the base such that the wick 92 dips into the lamp oil within the receptacle 55 (to draw the oil upward for fueling the flame 90). The panels 60 are inserted into slots 70 and lid 82 positioned at the top of panels 60 to hold the panels in place. A match or lighter is used to light a flame to wick 90, and the flame raises into chamber 66 which is fueled by external air entering via elongated gaps 64 and/or via air openings 36. External air may also enter chamber 66 via side vents 44 where the external air passes into the base 30 and upward through openings 36 within the chamber area. External air may also enter chamber 66 via bottom air openings 39 where the external air passes into the base 30 and upward through openings 36 within the chamber area. As flow of external air varies, the motion of the flame 90 within the chamber will vary. In alternatives, the fuel receptacle 55 has an inner diameter which matches or nearly matches an inner diameter of annular wall 46 of wick cup 94. In aspects, stem 50, which contains receptacle 55, is connected to bottom member 38. In other aspects stem 50 and bottom member 38 are integrally connected. In further aspects, fuel receptacle is position within base 30 and wick cup 94 positioned at least partly within base 30 and partly extending above base 30. The device 20 may be presented on a stake 80 inserted into the ground 81 as would a typical torch lamp. Multiple devices 20 may be utilized to light and decorate a desired area. The device 21 may also be presented on a table flat surface for desired display.

In further aspects as may be appreciated throughout the drawings and the above disclosure the device comprises a base 30 configured to receive a plurality of transparent panels 60 which project upward from the base 30, the panels 60 oriented such that adjacent panels 60 define elongated gaps 64 between edges 62 of adjacent panels 60, the panels 60 at least in part defining a chamber 66, and a lid 82 positioned atop the panels 60, the lid 82 having an opening 84. In one aspect opening 84 is a central opening at an uppermost portion of the lid 82. The lid 82 allows for the panels to align securely in an upright position without undue movement. As may be appreciated, air may flow through elongated gaps 64 into the chamber 66 to fuel a flame 90 which projects upward from atop portion 32 of base 30. In alternatives or as optional features to use of lid 82, the base includes side vents 44 and/or top member openings 36 and/or bottom member air openings 39 which allow further input of external air into chamber 66 to fuel the flame 90. In one aspect the panels 60 insert into slots 70 within base 30. Panels 60 may be connected to base 30 in or with other means, including insertion of the panels into friction slots on top of base 30, or by other fastening mechanisms.

In further aspects a method of allowing external air to access a chamber of a flame lamp device is disclosed, the method including positioning upstanding transparent panels in slots at a top member of a base, the transparent panels in part forming a chamber, the base having at least one side vent, the panels positioned to form elongated gaps between adjacent transparent panels, orienting the panels in the slots in a spaced relationship with the base, thereby allowing external air to enter the at least one vent into the base and upward through the top member and into the chamber.

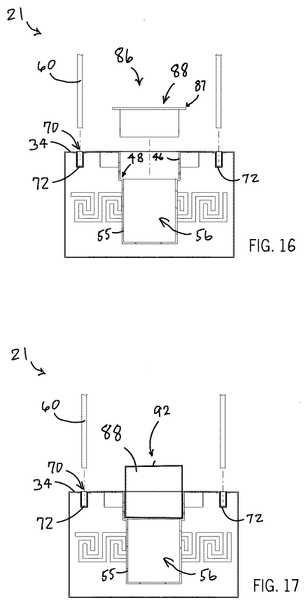

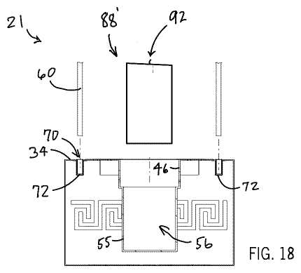

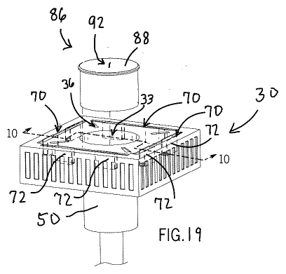

In a further aspect and with respect to the device 21 shown in FIG. 16, a candle holder 86 having a candle 88 therein is inserted into the receptacle 55, or into the receptacle defined by annular wall 46. Alternatively, a candle 88 may be directly placed into the receptacle 46, 55. In one aspect candle holder 86 includes a lip 87 which has a diameter sufficient to abut against the top portion 32 so that the candle holder 86 and candle 88 may be suspended at the top member 34. The candle 88 and/or candle holder 86 may have different depths as desired, such that the candle 88 may extend above the level of the top member 34 and extend below into the receptacle 55. In one aspect with respect to FIG. 17, candle 88 abuts against shoulder 48 within receptacle defined by annular wall 46, while a portion of the candle 88 extends above the top member 34. In further aspects, and with respect to FIG. 18, candle 88′ is elongated and may insert or extend downward into receptacle 55 while extending upwards to or beyond top member 34. It may be appreciated that device 20, 21 may use either a liquid fuel source or a candle (or even a supply of gas) to power the flame. In one aspect a wick cup 94 and liquid fuel reservoir may be used, or alternatively, a candle 88 or candle holder 86 used in the position of the receptacle 55, 46. The oil reservoir 56 may contain oil, or may alternatively receive a candle holder 86 or candle 88, 88′.

It should be understood, of course, that the foregoing relates to exemplary embodiments of the invention and that modifications may be made without departing from the spirit and scope of the invention as set forth in the following claims.

What is claimed is:

1. A flame lamp device, comprising:
a base having a top portion and a plurality of side vents;
at least three transparent panels projecting upward from the base, the panels oriented such that adjacent panels define elongated gaps between edges of the adjacent panels, the transparent panels at least in part defining a chamber, the top portion of the base having an opening configured to receive a candle holder, a candle, or a wick cup, the side vents in communication with the chamber, whereby the side vents and the elongated gaps allow air to flow into the chamber to feed a flame from the candle holder, candle or wick cup.

2. The flame lamp device of claim 1 further comprising a candle positioned in the opening.

3. The flame lamp device of claim 1 where the opening is in communication with a fuel receptacle configured to retain liquid.

4. The flame lamp device of claim 1 where the opening is in communication with a first receptable having a first annular wall, the first receptacle in communication with a second receptacle having a second annular wall, the first annular wall having a first diameter, the second receptacle having a second diameter, the first diameter being greater than the second diameter.

5. The flame lamp device of claim 1 where the opening is in communication with a receptacle, the receptacle defining a shoulder.

6. The flame lamp device of claim 5 where a candle or candle holder inserted into the receptacle abuts the shoulder.

7. The flame lamp device of claim 1 where the opening is in communication with a receptacle configured to receive a candle holder having a lip such that the lip abuts the top portion to suspend the candle holder in the receptacle.

8. The flame lamp device of claim 1 where the opening is in communication with a receptacle, the device further comprising a candle holder having a lip, the candle holder inserted into the receptacle such that the lip abuts the top portion.

9. The flame lamp device of claim 1 where the opening is in communication with a receptacle having a shoulder, the device further comprising a candle inserted into the receptacle and abutting the shoulder.

10. The flame lamp device of claim 1 where the opening is in communication with a receptacle, the device further comprising a candle positioned within the receptacle and extending above the top portion.

11. A flame lamp device, comprising:
a base having a top member and a bottom member, at least one air vent oriented between the top member and the bottom member;
the top member having a plurality of top member air openings, a top member central opening configured to allow a candle, candle holder, or wick cup to be positioned therein, and a plurality of slots configured to receive transparent members;
the bottom member having a plurality of bottom member air openings;
whereby the bottom member air openings and the at least one air vent allow air to flow into the base and upward through the top member air openings

12. The flame lamp device of claim 11 further comprising a plurality of transparent panels positioned in the slots, the transparent panels oriented such that adjacent transparent panels define elongated gaps between edges of the adjacent transparent panels, the transparent panels at least in part defining a chamber into which a flame may extend from the candle, candle holder or wick cup, whereby air flowing into the at least one air vent may travel to the chamber.

13. The flame lamp device of claim 11 further comprising a candle positioned within the top member central opening.

14. The flame lamp device of claim 11 further comprising a candle holder or a wick cup positioned within the top member central opening.

15. The flame lamp device of claim 11 further comprising a candle holder having a lip, the lip abutting the top member while the candle holder is positioned within the central opening.

16. A flame lamp device, comprising:
a base having a top member and a bottom member, a plurality of air vents oriented between the top member and the bottom member;
the top member having a plurality of top member air openings and a plurality of slots configured to receive transparent panels;
a plurality of transparent panels positioned in the slots, the transparent panels oriented such that adjacent transparent panels define elongated gaps between edges of the adjacent transparent panels, the transparent panels oriented in a spaced relationship with respect to the bottom member, the device further comprising a central opening defined by the top member, the central opening configured to receive a candle, a candle holder, or a wick cup.

17. The flame lamp device of claim 16 further comprising a stake positioned below the bottom member and extending downward.

18. The flame lamp device of claim 16 further comprising a candle positioned within a receptacle of the base, a flame from the candle extending upward into a chamber defined by the plurality of panels.
